(19) United States
(12) Patent Application Publication
(10) Pub. No.: US 2019/0025476 A1
(43) Pub. Date: Jan. 24, 2019

(54) SYSTEMS AND METHODS FOR THE GENERATION OF COHERENT LIGHT

(71) Applicant: Northwestern University, Evanston, IL (US)

(72) Inventors: Cheng Sun, Wilmette, IL (US); Hao F. Zhang, Deerfield, IL (US); Biqin Dong, Evanston, IL (US); Wenzhong Liu, San Diego, CA (US); Kieren J. Patel, Evanston, IL (US)

(73) Assignee: Northwestern University, Evanston, IL (US)

(21) Appl. No.: 16/068,819

(22) PCT Filed: Jan. 9, 2017
(86) PCT No.: PCT/US17/12723

§ 371 Date: Jul. 9, 2018

Related U.S. Application Data
(60) Provisional application No. 62/276,633, filed on Jan. 8, 2016.

(51) Int. Cl. G02B 5/00; G02B 19/00

(52) U.S. Cl. CPC G02B 5/008; G02B 27/30; G02B 19/0047; G02B 19/0009

(57) ABSTRACT

Systems and methods to generate spatially coherent electromagnetic radiation are disclosed. An example method includes receiving two or more incident wavelengths of electromagnetic radiation; applying the two or more incident wavelengths of electromagnetic radiation to an array of features; generating two or more spatially coherent optical resonating modes through the interaction of the one or more incident wavelengths of electromagnetic radiation and the array of features; and coupling the two or more spatially coherent optical resonating modes to two or more spatially coherent propagating wavelengths of electromagnetic radiation, wherein the spatially coherent propagating wavelengths of electromagnetic radiation are identical to the two or more incident wavelengths of electromagnetic radiation. An example system includes an array of features configured to receive wavelengths of electromagnetic radiation; medium(s) configured to generate spatially coherent optical resonating mode(s); and medium(s) configured to generate spatially coherent propagating wavelength(s) of electromagnetic radiation.

### CROSS-REFERENCE

This application claims the benefit of priority to PCT Patent Application No. PCT/US17/12723, entitled “Systems and Methods for the Generation of Coherent Light,” filed on Jan. 9, 2017, which claims the benefit of priority to U.S. Patent Application No. 62/276,633, entitled “Device, Composition And Methods For Coherent Light Source,” filed Jan. 8, 2016, each of which is incorporated herein by reference in its entirety for all purposes.

### STATEMENT REGARDING FEDERALLY SPONSORED RESEARCH FOR DEVELOPMENT

This invention was made with government support under grant numbers CMMI-0955195 and STTR Phase 1 1622907 awarded by the National Science Foundation. The government has certain rights in the invention.

### BACKGROUND OF THE DISCLOSURE

Nanostructured materials have been widely employed for achieving various functionalities at the nanoscale due to their ability to interact, confine and enhance electromagnetic fields. In some instances, nano structured environments enable tailoring and manipulation of optical interactions on subwavelength scales. High refractive index dielectrics and new advances with manufacturing of nanostructures with plasmonic materials, including metallic and semiconductor-based compounds, have enabled new possibilities for achieving novel subwavelength light-matter interactions. These recent advances have made possible the design and manufacturing of numerous novel optical devices.

Multiple imaging modalities exist for a variety purposes ranging from biomedical applications to industrial monitoring. For biomedical imaging modalities such as optical coherence tomography (OCT), which is widely used as an imaging diagnostic tool, imaging is dependent on light sources with high coherence, generally provided by lasers. Despite the success of laser based light sources for devices involved in applications such as OCT, lasers remain costly and in some cases, bulky. In some examples, reliance on laser light sources may limit application of certain devices, such as in certain OCT applications. There is need in the art for improved alternative light sources for the generation of light with high coherence, wherein the light sources do not rely on lasers. Novel light source devices, such as those employing nanostructured environments, may improve functionality, commercial success, and types of imaging devices requiring coherent light.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of a device of this disclosure are set forth with particularity in the appended claims. A better understanding of the features and advantages of this disclosure will be obtained by reference to the following detailed description that sets forth illustrative examples, in which the principles of a device of this disclosure are utilized, and the accompanying drawings of which:

FIG. 1 depicts a sample flow diagram of an example method to facilitate interaction between light and an array of features of the present disclosure.

FIG. 2 illustrates an example system for coherent light generation.

FIG. 3 depicts schematic representations of various configurations of the device or systems of the present disclosure. FIG. 3a represents a basic configuration of a single device, wherein coherent light generated by a device can be focused on a fiber tip. FIG. 3b represents a configuration of a device comprising an array of features designed to include holes or nano-holes. FIG. 3c represents a configuration of a device comprising an array of features designed to include grooves or nano-grooves. FIG. 3d represents a configuration of a device comprising an array of features designed to include spheres or nanospheres. FIG. 3e represents a configuration of a device comprising an array of features designed to include pillars or nanopillars. FIG. 3f represents a configuration of a device comprising an array of features designed to include multiple circular arrays, each array comprising a decreasing diameter such that the multiple arrays are aligned in cone configuration.

FIG. 4 depicts an example flow diagram of an example method to facilitate interactions between light and an array of features of the present disclosure.

FIG. 5 illustrates a block diagram of an example system for generation of coherent light to a device.

FIG. 6 is a schematic representation of a device configured to generate coherent light in the visible light spectrum using one light source for incident wavelengths of light.

FIG. 7 illustrates example data collected, validating the generation of coherent light from an example device of the present disclosure

FIG. 8 illustrates a schematic an example device configured for generating coherent light that can be coupled into an optical fiber.

FIG. 9 illustrates an image a) and schematic b) for one or more devices configured with a taper design for coupling into a fiber.

FIG. 10 depicts a schematic representation of a simulated optical setup for fiber coupling using the present disclosure.

FIG. 11 is a block diagram of an example processor structured to execute example machine-readable instructions of FIGS. 1 and 4 to implement the example systems of FIGS. 2, 3, 5, 6, 8, 9, and 10.

The following detailed description of certain examples of the present disclosure will be better understood when read in conjunction with the appended drawings. For the purpose of illustrating the disclosure, certain examples are shown in the drawings. It should be understood, however, that the present disclosure is not limited to the arrangements and instrumentality shown in the attached drawings.

### DETAILED DESCRIPTION OF THE DISCLOSURE

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and other changes may be made without departing from the scope of the subject matter of this disclosure. The following detailed description is, therefore, provided to describe an exemplary implementation and not to be taken as limiting on the scope of the subject matter described in this disclosure. Certain features from different aspects of the following description may be combined to form yet new aspects of the subject matter discussed below.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

### I. General Overview

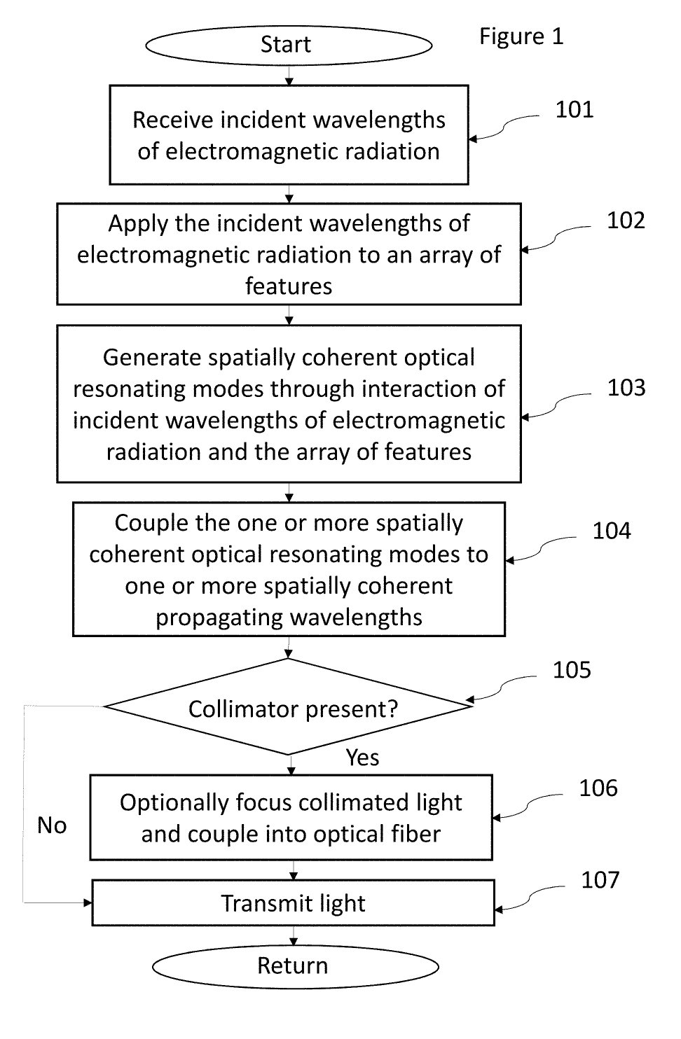

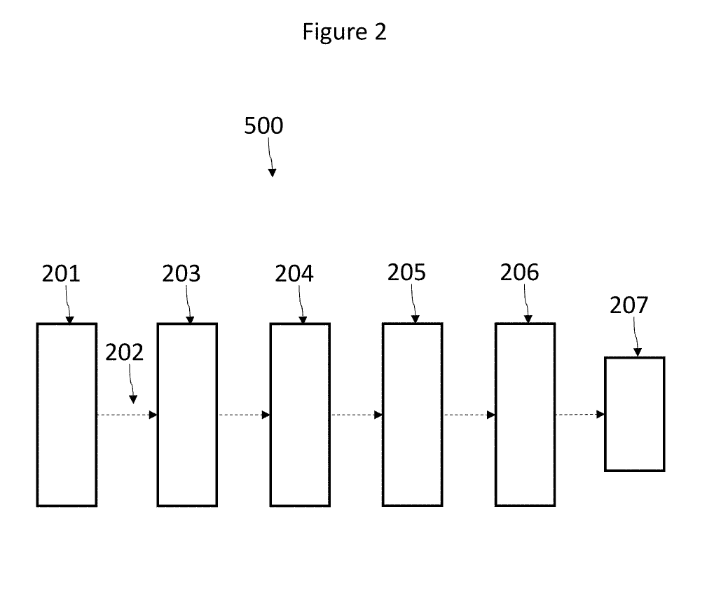

Generally, the present disclosure describes one or more systems, devices and methods for generating coherent light or electromagnetic radiation, as shown by example in FIG. 1. At block 101, incident light of low or partial coherence is received. For example, incident light 201 of low or partial coherence (e.g., light having incident wavelengths of 500-600 nm, etc.) is received from a light source 202 in the example system 200 of FIG. 2. At block 102, the incident light is applied to one or more arrays of features. For example, as shown in FIG. 2, an array of features 203 receives the incident light 201. At block 103, the incident light interacts with the array of features to generate one or more spatially coherent resonating modes. Further, at block 104, the one or more systems, devices and methods of the present disclosure are configured to couple the one or more spatially coherent optical resonating modes to one or more spatially coherent propagating wavelengths. For example, as shown in FIG. 2, a coupler 204 couples the one or more optical resonating nodes to one or more wavelengths. In some examples, coherent light can be generated and transmitted from one or more devices. For example, as shown in FIG. 2, a generator 205 generates light from the mode(s) coupled to the wavelength(s). At block 105, system configuration is checked for presence of a collimator. If the collimator is present, then, at block 106, coherent light generated from one or more device can be collimated and coupled into an optical fiber. For example, as shown in FIG. 2, a collimator 206 receives and collimates the light, which is then provided to a fiber 207. At block 107, the light is transmitted and/or otherwise relayed.

Generally, the array of features can be configured in a variety of ways to achieve increased coherence of incident wavelength of light to generate light of comparatively higher coherence. In some examples, white light, or visible light can be used to generate incident wavelengths of light. In this example, coherent light, or light with increased coherence with visible light wavelengths can be generated. Any form of electromagnetic radiation, including but not limited to x rays, gamma rays, visible light, ultraviolet (UV) light, near infrared (NIR) light and the like, can be used and generated with the systems, methods and devices of the present disclosure.

In some examples, an array of features can include one or more structures that allow for the interaction of light or electromagnetic radiation with the array to generate coherent light or light with increased coherence compared to the coherence of incident light. In some examples, the array of features include one or more nanostructures, including but not limited to nanohole arrays, nanopillars, nanoribbons, nanocurls and the like.

Generally, the wavelengths of incident light are identical to the wavelengths of light generated from the systems, devices and methods of the present disclosure.

In some examples, coherent light generated from the systems, devices and methods of the present disclosure can be coupled into a fiber optic and can be used for applications that utilize such fiber based light sources. By way of example, such applications can include applications utilizing optical coherence tomography (OCT). OCT based devices can be used for a diversity of applications, including but not limited to art conservation and diagnostic medicine, notably in ophthalmology and optometry where it can be used to obtain detailed images from within the retina. OCT devices can also be used for interventional cardiology to help diagnose coronary artery disease, to monitor implantation of vascular stents or for endoscopic OCT based devices for visualizing cavities, vessel structures and the like. Additionally, the systems and methods of the present disclosure when coupled into a fiber optic can be used for other applications that utilize coherent light such as machine vision systems, or confocal microscopy.

### II. Sources of Incident Wavelengths of Electromagnetic Radiation

Generally, the systems and methods of the disclosure can be configured with any suitable source of incident wavelengths of electromagnetic radiation. In some examples, a non-laser light source, or light source that generates wavelengths of electromagnetic radiation with low coherence is used to generate incident wavelengths of light. In some examples, non-laser light sources can be used, including but are not limited to light-emitting diodes (LEDs), organic light-emitting diodes (OLEDs), polymer light-emitting diodes (PLEDs), active-matrix organic light-emitting diode (AMOLED), light-emitting electrochemical cell (LEEC), electroluminescent wires, such as in a bulb, or field-induced polymer electroluminescent source. In some examples, one or more different light sources of non-laser light be used alone or in combination with the systems and methods of the disclosure.

Generally, any incident wavelengths of electromagnetic radiation can be received by the array of features of the systems and methods of the disclosure. In some examples, one or more incident wavelengths can be received by the array of features of the systems and methods of the disclosure. In some examples two or more incident wavelengths can be received by array of features of the systems and methods of the disclosure. In some examples, a plurality of wavelengths comprising a narrow band of incident wavelengths, or wide band of incident wavelengths can be received by array of features of the systems and methods of the disclosure.

Generally, the incident wavelengths of light can be selected based on the desired wavelengths of coherent electromagnetic radiation to be transmitted by one or more coherent propagating waves. The systems and methods of the present disclosure provide for the generation of coherent wavelengths of electromagnetic radiation identical to the non-coherent, or lower coherent incident wavelengths of light.

In some examples, a visible light spectrum of light is generated by a non-laser light source and received by the array of features of the systems and methods of the disclosure. In some examples, a white light LED, or similar device can be used. In some examples, the incident wavelengths can range from about 500 nm to about 620 nm. In some examples, the incident wavelengths can range between 200 nm to 600 nm. In some examples, the incident wavelengths can range between 300 to 900 nm. In some examples, the incident wavelengths can range between 500 nm to 1200 nm. In some examples, the wavelength can range between 500 nm to 800 nm. In some examples, the two or more incident wavelengths can include wavelengths of 200 nm, 210 nm, 220 nm, 230 nm, 240 nm, 250 nm, 260 nm, 270 nm, 280 nm, 290 nm 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 900 nm, 1000 nm, 1100 nm, 1200 nm, 1300 nm, 1400 nm and 1500 nm. In some examples, the wavelength can include a continuous band wavelength ranging from about 200 nm to 500 nm. In some examples, the wavelength can include a continuous band wavelength ranging from about 100 nm to 700 nm. In some examples, the wavelength can include a continuous band wavelength ranging from about 300 nm to 800 nm. In some examples, the wavelength can include a continuous band wavelength ranging from about 400 nm to 900 nm. In some examples, the wavelength can include a continuous band wavelength ranging from about 500 nm to 1200 nm. In some examples, the wavelength can include a continuous band wavelength ranging from about 550 nm to 1500 nm.

In some examples, the systems and methods of the disclosure can be used with invisible incident wavelengths of electromagnetic radiation, including but are not limited to extreme ultraviolet light, at or around wavelengths of 10 nm; near ultraviolet light, at or around wavelengths of 100 nm; near infrared (NIR), at or around wavelengths of 1 μm; mid infrared, at or around wavelengths of 10 μm; far infrared, at or around wavelengths of 100 μm; mid infrared, and microwaves at or around wavelengths of 1 mm, 10 mm, 100 mm or 1 cm.

Generally, a suitable power output of a device for generating incident wavelengths of electromagnetic radiation can be selected. In some examples the power output of the device for generating incident wavelengths of electromagnetic radiation can include at least about 0.1 mW, 0.2 mW, 0.3 mW, 0.4 mW, 0.5 mW, 0.6 mW, 0.7 mW, 0.8 mW, 0.9 mW, 1.0 mW, 1.1 mW, 1.2 mW, 1.3 mW, 1.4 mW, 1.5 mW, 1.6 mW, 1.7 mW, 1.8 mW, 1.9 mW, 2.0 mW, 3.0 mW, 4.0 mW, 5.0 mW, 6.0 mW, 7.0 mW, 8.0 mW, 9.0 mW and 10.0 mW. In some examples, the power output of the device for generating incident wavelengths of electromagnetic radiation can include at most about 0.1 mW, 0.2 mW, 0.3 mW, 0.4 mW, 0.5 mW, 0.6 mW, 0.7 mW, 0.8 mW, 0.9 mW, 1.0 mW, 1.1 mW, 1.2 mW, 1.3 mW, 1.4 mW, 1.5 mW, 1.6 mW, 1.7 mW, 1.8 mW, 1.9 mW, 2.0 mW, 3.0 mW, 4.0 mW, 5.0 mW, 6.0 mW, 7.0 mW, 8.0 mW, 9.0 mW and 10.0 mW. In some examples, the power output ranges from 0.1 mW to 0.5 mW. In some examples, the power output ranges from 0.5 mW to 1.0 mW. In some examples, the power output ranges from 0.24 mW to 0.75 mW. In some examples, the power output ranges from 0.4 mW to 1.0 mW. In some examples the power output ranges from 0.5 mW to 1.5 mW. In some examples, the power output ranges from 0.75 mW to 5.0 mW. In some examples, the power output ranges from 1 mW to 10.0 mW. In some examples the power output ranges from 6.0 mW to 10.0 mW. In some examples, the power output ranges from 4.0 mW to 8.0 mW.

In some examples, the one or more incident wavelengths of electromagnetic radiation can be non-coherent. In some examples, the one or more incident wavelengths of electromagnetic radiation can be partially coherent. In some examples, the one or more incident wavelengths of electromagnetic radiation can be low-coherent. Generally, coherence can refer to spatial coherence, where there exists a strong correlation (fixed phase relationship) between the electric fields at different locations across the beam profile of wavelengths of light. For example, within a cross-section of a beam from a light source with diffraction-limited beam quality, the electric fields at different positions oscillate in a totally correlated way, even if the temporal structure can be complicated by a superposition of different frequency components.

Generally, the systems and methods of the disclosure provide for receiving two or more incident wavelengths of electromagnetic radiation with non-coherence, partial coherence, or low coherence and converting the electromagnetic radiation into identical wavelengths of light with coherence higher than then coherence of the incident wavelengths of light.

In some examples, coherence can be measured as percentage coherence of light. In some examples, low coherence or partial coherence can include at most about 0.1%, 0.5, 1.0%, 2%, 3%, 4%, 5%, 6%, 7%, 8%, 9%, 10%, 15%, 20%, 25%, 30%, 35, 40%, 45%, 50%, 60%, 70%, 80%, or 90%. In some examples, low coherence or partial coherence can range from 0.1% to 5%. In some examples, low coherence or partial coherence can range from 1% to 10%. In some examples, low coherence or partial coherence can range from 5% to 40%. In some examples, low coherence or partial coherence can range from 10% to 60%. In some examples, low coherence or partial coherence can range from 15% to 75%. In some examples, low coherence or partial coherence can range from 20% to 50%.

In some examples, the amount of spatial coherence in the propagating wavelengths of electromagnetic radiation can be increased as compared to the spatial coherence of the incident wavelengths of electromagnetic radiation. In some examples, the amount of increase can be at least about 0.1%, 0.5, 1.0%, 2%, 3%, 4%, 5%, 6%, 7%, 8%, 9%, 10%, 15%, 20%, 25%, 30%, 35, 40%, 45%, 50%, 60%, 70%, 80%, or 90%. In some examples, the amount of increase can be at most about 0.1%, 0.5, 1.0%, 2%, 3%, 4%, 5%, 6%, 7%, 8%, 9%, 10%, 15%, 20%, 25%, 30%, 35, 40%, 45%, 50%, 60%, 70%, 80%, or 90%. In some examples, the difference in spatial coherence between incident wavelengths of electromagnetic radiation and propagating wavelengths of electromagnetic radiation can range from 1% to 10%. In some examples, the difference in spatial coherence between incident wavelengths of electromagnetic radiation and propagating wavelengths of electromagnetic radiation can range from 5% to 40%. In some examples, the difference in spatial coherence between incident wavelengths of electromagnetic radiation and propagating wavelengths of electromagnetic radiation can range from 10% to 60%. In some examples, the difference in spatial coherence between incident wavelengths of electromagnetic radiation and propagating wavelengths of electromagnetic radiation can range from 15% to 75%. In some examples, the difference in spatial coherence between incident wavelengths of electromagnetic radiation and propagating wavelengths of electromagnetic radiation can range from 20% to 50%.

Generally, the measure of coherence can be quantified using any suitable method or metric as known in the art. In some examples, coherence, including both spatial and temporal coherence, can be measured by mutual coherence functions. In such examples, mutual coherence functions specify the degree of coherence as a function of fringe modulations. Generally, the two or more spatially coherent propagating wavelengths of electromagnetic radiation include wavelengths of higher coherence than the coherence of the incident wavelengths.

In some examples coherence can be measured or determined using any method suitable in the art. In some examples, a Young's double-slit interferometer combined with a spectrometer can be used to determine if the two or more spatially coherent propagating wavelengths of electromagnetic radiation include wavelengths of higher coherence than the coherence of the incident wavelengths. The degree of coherence in the Yong's double slit experiments can be quantified by the visibility of the intensity fringes produced in the interference patents, which is the ratio of difference between constructive interference fringe and destructive interference fringe and the sum of constructive interference fringe and destructive interference fringe.

Generally, the arrays of features of the device produce two or more spatially coherent propagating wavelengths of electromagnetic radiation that include wavelengths of higher coherence than the coherence of the incident wavelengths. In some examples, the incident wavelengths of electromagnetic radiation are non-coherent, or are 0% coherent. In some examples, the propagating wavelengths of electromagnetic radiation are 100% coherent. In some examples, incident wavelengths of electromagnetic radiation may be partially coherent. In some examples, the coherence of the propagating wavelengths of electromagnetic radiation are higher than the coherence of the incident wavelengths of electromagnetic radiation by at least about 0.1%, 0.5, 1.0%, 2%, 3%, 4%, 5%, 6%, 7%, 8%, 9%, 10%, 15%, 20%, 25%, 30%, 35, 40%, 45%, 50%, 60%, 70%, 80%, 90%, 95%, 99%, 99.9%, 99.999%, or 100%. In some examples, the percent coherence of the propagating wavelengths of electromagnetic radiation is higher than the coherence of the incident wavelengths by a range of about 0.1% to 5%. In some examples, the percent coherence of the propagating wavelengths of electromagnetic radiation is higher than the coherence of the incident wavelengths by a range of about 1% to 10%. In some examples, the percent coherence of the propagating wavelengths of electromagnetic radiation is higher than the coherence of the incident wavelengths by a range of about 5% to 40%. In some examples, the percent coherence of the propagating wavelengths of electromagnetic radiation is higher than the coherence of the incident wavelengths by a range of about 10% to 60%. In some examples, the percent coherence of the propagating wavelengths of electromagnetic radiation is higher than the coherence of the incident wavelengths by a range of about 15% to 75%. In some examples, the percent coherence of the propagating wavelengths of electromagnetic radiation is higher than the coherence of the incident wavelengths by a range of about 20% to 50%. In some examples, the percent coherence of the propagating wavelengths of electromagnetic radiation is higher than the coherence of the incident wavelengths by a range of about 50% to 100%. In some examples, the percent coherence of the propagating wavelengths of electromagnetic radiation is higher than the coherence of the incident wavelengths by a range of about 75%-99%. In some examples, the percent coherence of the propagating wavelengths of electromagnetic radiation is higher than the coherence of the incident wavelengths by a range of about 90-100%. In some examples, the percent coherence of the propagating wavelengths of electromagnetic radiation is higher than the coherence of the incident wavelengths by a range of about 80-100%.

### III. Design and Fabrication of Featured Arrays and Photonic Materials

Generally, an array of features of the present disclosure is configured and optimized to produce the one or more spatially coherent optical resonating modes from the one or more incident wavelengths of electromagnetic radiation.

In some examples, the array of features can be a series of structure or nanostructures arranged in a periodic, quasi-random, quasi-ordered or random arrangement. In some examples, the array of features can be textured material, wherein features can be arranged with a combination of periodic, quasi-random, quasi-order or random order. Generally, an array is any arrangement of distinct structures. In some examples, the array of features can refer to a one-dimensional, two-dimensional or three-dimensional arrangement of features, as needed for a particular application.

In some examples and as known in the art, the array of features can be ordered or randomly arranged. Generally, order can include having a defined spacing between individual features. In some examples, design of an array of features of the systems and methods of the disclosure can include features with the same or substantially similar distances between features. In some examples, periodic or ordered features can include a design that includes a range of distances between features, wherein the features still form a geometric pattern. By way of example, such patterns can include a hexagon pattern, a circular pattern, or a pattern containing one or more holes. In some examples, the features are arranged in a predetermined pattern or design. In some examples, the features can be designed and arranged in any type of one or more definable patterns. In some examples, the array of features can include an array of features that are designed and deposited at random. In some examples, the distances between features may range based on a random deposition without predefining the distances between features. In some examples, a quasi-ordered, or quasi-random array of features may be used. In some examples, a quasi-ordered arrangement can include a combination of periodic or ordered arrangements with a random deposition of features. In some examples, a quasi-ordered or quasi random array of features may contain features wherein the distance between features ranges between a defined range. In some examples, a quasi-ordered or quasi random array of features may contain features wherein the distance between features, or spacing, ranges between a range not predetermined before deposition.

Generally, the systems and methods of the present disclosure utilize one or more arrays of features, wherein the size, geometry and spacing of the features are configured and optimized and/or otherwise configured to produce the one or more spatially coherent optical resonating modes from the one or more incident wavelengths of electromagnetic radiation. In some examples, one or more features of the array can include nanostructures, plasmonic structures, photonic optical resonators, photonic cavities, photonic crystals, holes, nano-holes, nano-pores, or random textured surfaces. By way of example, nanostructures can be any suitable geometry, including but not limited to structures such as holes, pillars, spheres, spherical bodies, spirals, coils, polygons, wires, grooves, slits, nanocages, nanospheres, nanochains, nanofibers, nanoflakes, nanoflowers, nanofoams, nanomesh, nanoparticle, nanopillars, nanopin films, nanoplatelets, nanoribbons, nanorings, nanorods, nanosheets, nanoshells, nanotips, nanowires, quantum dots, quantum heterostructures and the like.

In some examples and as known in the art, a nanostructure is any structure having a dimension size less than 10 nm. In some examples, such as nano-holes, nano-pores, the diameter of the hole or pore can be less than 10 nm in distance. In some examples the diameter of a nanohole or nanopore can be 1 nm. In some examples, nanostructures are features with a specific shape or geometry, wherein individuals features are designed to be specific size as described herein. By way of example, a nanosphere can include any spherical shaped feature, wherein individual features are less than 10 nm. By way of example, a nanopillar can include any cylindrical shaped featured, wherein individual features are less than 10 nm. By way of example, a nano-groove can include any slit based feature, wherein individual features are less than 10 nm.

In some examples and as known in the art, a photonic cavity, photonic optical resonator can be any structure designed to confine light at resonance frequencies. In some examples, optical resonators or photonic cavities can be characterized by the ability to confine optical energy temporally and spatially.

In some examples, an array of features may be a textured surface wherein the textured surface has an ascertainable topography. In some examples, a textured surface can include any surface containing small local deviations of a surface from the perfectly flat ideal (e.g., a true plane, etc.).

The array of features, or textured surfaces can be generated or manufactured with a variety of methods known in the art and as described herein. Arrays or surfaces may be generated using electron beam deposition (EBID), or plasma enhanced atomic layer deposition. In some examples, textured surfaces may be produced via machining a flat surface by boring one or more holes of a chosen diameter. By way of example, surfaces may also be generated through grinding (abrasive cutting), polishing, lapping, abrasive blasting, honing, electrical discharge machining (EDM), milling, lithography, industrial etching/chemical milling, laser texturing, or other processes.

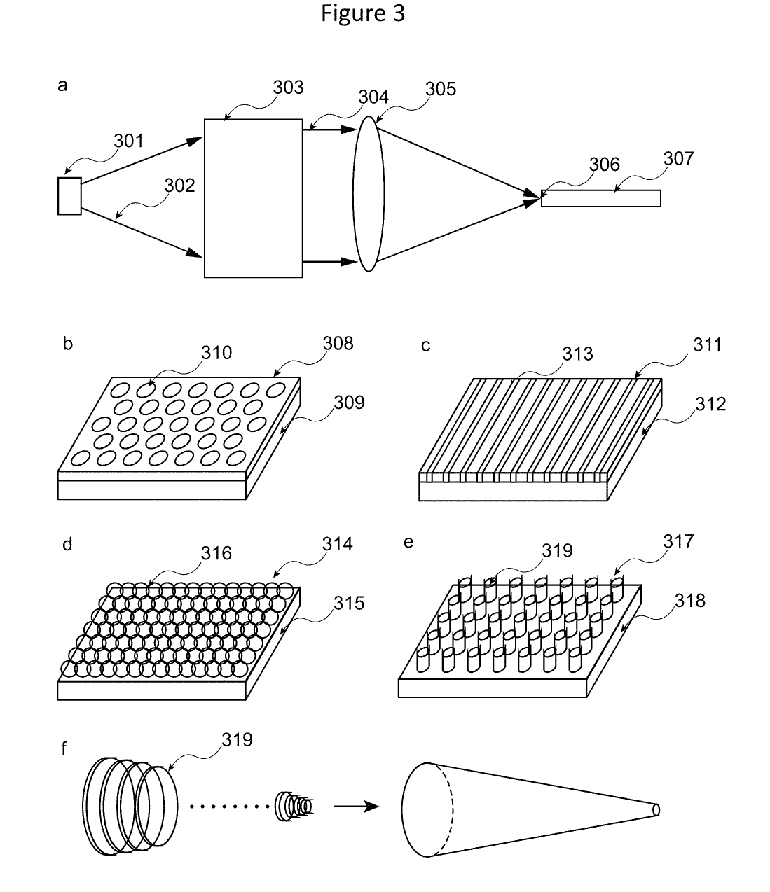

FIG. 3a-f provide examples of different configurations and designs for the array of features. FIG. 3a shows a basic configuration, in which a low, partial or non-coherent light source 301, generates light 302 to be received by an array of features 303. The light transmitted from the array of features 303, which can include coherent light or light with increased coherent as compared to the incident wavelengths of light 304, can be passed through a focusing lens 305 which allows the coherent light to be focused through an aperture 306 of an optical fiber 307 or fiber tip.

FIG. 3b illustrates a schematic of an array of features that include holes. The configuration can include a plasmonic material, such as gold 308, in which hole(s) 310 are formed and deposited on another material 309 with a similar or different dielectric constant as the plasmonic material. By way of example and as known in the art, a plasmonic materials such as gold, silver, copper or any material showing metal-like optical properties may be deposited on a suitable substrate. In some examples, the substrate may be quartz, silicon, or silica containing materials such as glass or mica.

FIG. 3c shows a schematic of an array of features that include grooves or slits. The configuration can include a plasmonic material 313, such as gold, in which groove(s) 311 are formed and deposited on another material 313 with a similar or different dielectric constant as the plasmonic material.

FIG. 3d provides for a schematic of an array of features that include nanospheres. The configuration can include a plasmonic material 316, such as gold, in which nanosphere(s) 314 are formed and deposited on another material 315 with a similar or different dielectric constant as the plasmonic material.

FIG. 3e shows a schematic of an array of features that include nanopillars. The configuration can include a plasmonic material 319, such as gold, in which nanopillar(s) 317 are formed and deposited on another material 318 with a similar or different dielectric constant as the plasmonic material.

FIG. 3f represents a configuration of a device including an array of features designed to include multiple circular arrays, each array including a decreasing diameter such that the multiple arrays are aligned in a cone configuration. Each array can include a plasmonic material 319.

Generally, one or more features of the features of arrays, can have any suitable dimension. In some examples, one or more features can be selected to have a dimension size less than then wavelength of at least one of the incident wavelengths of electromagnetic radiation. In some cases, a feature can be at least about 0.1 nm, 0.2 nm, 0.3 nm, 0.4 nm, 0.5 nm, 0.6 nm, 0.7 nm, 0.8 nm, 0.9 nm, 1.0 nm, 1.1 nm, 1.2 nm, 1.3 nm, 1.4 nm, 1.5 nm, 1.6 nm, 1.7 nm, 1.8 nm, 1.9 nm, 2.0 nm, 3 nm, 4 nm, 5 nm, 6 nm, 7 nm, 8 nm, 9 nm, 10 nm, 20 nm, 30 nm, 40 nm, 50 nm, 60 nm, 70 nm, 80 nm, 90 nm, 100 nm, 150 nm, 200 nm, 250 nm, 300 nm, 350 nm, 400 nm, 500 nm, 550 nm, 600 nm, 650 nm, 700 nm, 750 nm, 800 nm, 850 nm 900 nm, 950 nm, or 1000 nm. In some cases, a feature can be at most about 0.1 nm, 0.2 nm, 0.3 nm, 0.4 nm, 0.5 nm, 0.6 nm, 0.7 nm, 0.8 nm, 0.9 nm, 1.0 nm, 1.1 nm, 1.2 nm, 1.3 nm, 1.4 nm, 1.5 nm, 1.6 nm, 1.7 nm, 1.8 nm, 1.9 nm, 2.0 nm, 3 nm, 4 nm, 5 nm, 6 nm, 7 nm, 8 nm, 9 nm, 10 nm, 20 nm, 30 nm, 40 nm, 50 nm, 60 nm, 70 nm, 80 nm, 90 nm, 100 nm, 150 nm, 200 nm, 250 nm, 300 nm, 350 nm, 400 nm, 500 nm, 550 nm, 600 nm, 650 nm, 700 nm, 750 nm, 800 nm, 850 nm 900 nm, 950 nm, or 1000 nm. In some examples, a feature can range from 0.1 nm to 1 nm. In some examples, a feature can range from 1 nm to 10 nm. In some examples, a feature can range from 10 nm to 100 nm. In some examples, a feature can range from 50 nm to 200 nm. In some examples, a feature can range from 100 nm to 300 nm. In some examples, a feature can range from 50 nm to 200 nm. In some examples, a feature can range from 100 nm to 500 nm.

Generally, one or more features of the features of arrays can have any suitable spacing. Spacing can be defined as the minimum distance between one feature and another feature. In some cases, features can be spaced at least about 0.1 nm, 0.2 nm, 0.3 nm, 0.4 nm, 0.5 nm, 0.6 nm, 0.7 nm, 0.8 nm, 0.9 nm, 1.0 nm, 1.1 nm, 1.2 nm, 1.3 nm, 1.4 nm, 1.5 nm, 1.6 nm, 1.7 nm, 1.8 nm, 1.9 nm, 2.0 nm, 3 nm, 4 nm, 5 nm, 6 nm, 7 nm, 8 nm, 9 nm, 10 nm, 20 nm, 30 nm, 40 nm, 50 nm, 60 nm, 70 nm, 80 nm, 90 nm, 100 nm, 150 nm, 200 nm, 250 nm, 300 nm, 350 nm, 400 nm, 500 nm, 550 nm, 600 nm, 650 nm, 700 nm, 750 nm, 800 nm, 850 nm 900 nm, 950 nm, or 1000 nm. In some cases, features can be spaced at most about 0.1 nm, 0.2 nm, 0.3 nm, 0.4 nm, 0.5 nm, 0.6 nm, 0.7 nm, 0.8 nm, 0.9 nm, 1.0 nm, 1.1 nm, 1.2 nm, 1.3 nm, 1.4 nm, 1.5 nm, 1.6 nm, 1.7 nm, 1.8 nm, 1.9 nm, 2.0 nm, 3 nm, 4 nm, 5 nm, 6 nm, 7 nm, 8 nm, 9 nm, 10 nm, 20 nm, 30 nm, 40 nm, 50 nm, 60 nm, 70 nm, 80 nm, 90 nm, 100 nm, 150 nm, 200 nm, 250 nm, 300 nm, 350 nm, 400 nm, 500 nm, 550 nm, 600 nm, 650 nm, 700 nm, 750 nm, 800 nm, 850 nm 900 nm, 950 nm, or 1000 nm. In some examples, feature spacing can range from 0.1 nm to 1 nm. In some examples, feature spacing can range from 1 nm to 10 nm. In some examples, feature spacing can range from 10 nm to 100 nm. In some examples, feature spacing can range from 50 nm to 200 nm. In some examples, feature spacing can range from 100 nm to 300 nm. In some examples, feature spacing can range from 50 nm to 200 nm. In some examples, feature spacing can range from 100 nm to 500 nm.

Generally, one or more features of the array of features can be spaced in a quasi-periodic, quasi-random, or quasi-ordered design, wherein spacing between features falls within a defined distance range. In some examples, feature spacing can range from 0.1 nm to 1 nm. In some examples, feature spacing can range from 0.001 nm to 1 nm. In some examples, feature spacing can range from 0.01 nm to 1 nm. In some examples, feature spacing can range from 0.05 nm to 1 nm. In some examples, feature spacing can range from 0.1 nm to 0.5 nm. In some examples, feature spacing can range from 1 nm to 10 nm. In some examples, feature spacing can range from 10 nm to 100 nm. In some examples, feature spacing can range from 50 nm to 200 nm. In some examples, feature spacing can range from 100 nm to 300 nm. In some examples, feature spacing can range from 50 nm.

Generally, one or more features of the features of arrays can have any suitable geometry of spacing. In some examples, features can be arranged in random, or semi random order of lattice arrangement. In some cases, features can be arranged in an ordered pattern. In some examples, an array of features can be a mix of different lattice geometries or a mix of ordered and non-ordered arrangement of features. By way of example, features can be arranged as a triclinic, triagonal, monoclinic, orthorhombic, tetragonal, hexagonal, rhombohedral, square, or cubic lattice geometries.

Generally, any suitable material or materials can be used to optimize or produce the one or more spatially coherent optical resonating modes from the one or more incident wavelengths of electromagnetic radiation. In some examples, the systems or methods of the disclosure can include one or more different types of materials, wherein each material includes an array of features. In some examples, an array of features can include materials suitable for surface plasmon resonance. In some examples, an array of features can include plasmonic materials including but not limited to any material that uses surface plasmons to achieve an optical property. In some examples, incident wavelengths of electromagnetic radiation interact with materials that create self-sustaining propagating electromagnetic waves. In some examples, plasmonic materials can include but are not limited to composites, semiconductors, metals, gold, silver, copper, graphene, silicon, aluminum, aluminum scandium nitride, titanium, or titanium nitride.

Generally, any suitable methods of fabrication can be used to fabricate one or more array of features. By way of example, suitable methods can include but are not limited to milling, lithographic processes, machining, photolithography using visible light or UV-light or x-rays, electron beam lithography, Focused-Ion-Beam (FIB) techniques, Electro-beam-lithography (EBL) techniques, nanomanufacturing methods, or nanoimprint lithography.

Generally, the size of the array of features can be any suitable size for the desired output of the propagating wavelengths of electromagnetic radiation. In some examples, the array of features can be at least about 0.1 nm², 0.5 nm², 1.0 nm², 10 nm², 20 nm², 30 nm², 40 nm², 50 nm², 60 nm², 70 nm², 80 nm², 90 nm², 100 nm², 150 nm², 200 nm², 250 nm², 300 nm², 350 nm², 400 nm², 500 nm², 550 nm², 600 nm², 650 nm², 700 nm², 750 nm², 800 nm², 850 nm² 900 nm², 950 nm², 1000 nm², 1250 nm², 1500 nm², 1750 nm², 2000 nm², 2500 nm², 3000 nm², 3500 nm² 4000 nm², 5000 nm², 6000 nm², 7000 nm² 8000 nm² 9000 nm² 10,000 nm². In some cases, features can be spaced at most about 0.1 nm², 0.5 nm², 1.0 nm², 10 nm², 20 nm², 30 nm², 40 nm², 50 nm², 60 nm², 70 nm², 80 nm², 90 nm², 100 nm², 150 nm², 200 nm², 250 nm², 300 nm², 350 nm², 400 nm², 500 nm², 550 nm², 600 nm², 650 nm², 700 nm², 750 nm², 800 nm², 850 nm² 900 nm², 950 nm², 1000 nm², 1250 nm², 1500 nm², 1750 nm², 2000 nm², 2500 nm², 3000 nm², 3500 nm² 4000 nm², 5000 nm², 6000 nm², 7000 nm² 8000 nm² 9000 nm², 10,000 nm², 100 mm², 1 cm², 10 cm², 100 cm², 1,000 cm²′. In some examples, the array of features can range is area from 10 nm² to 100 nm². In some examples, the array of features can range is area from 100 nm² to 1000 nm². In some examples, the array of features can range is area from 50 nm² to 1600 nm². In some examples, the array of features can range is area from 1000 nm² to 5,000 nm². In some examples, the array of features can range is area from 1000 nm² to 10,000 nm². In some examples, the array of features can range is area from 10,000 nm² to 100,000 nm². In some examples, the array of features can range is area from 100,000 nm² to 1,000,000 nm². In some examples, the array of features can range is area from 1 nm² to 100 mm². In some examples, the array of features can range is area from 10,000 nm² to 1,000 cm². In some examples, the array of features can range is area from 5000 nm² to 10 cm². In some examples, the array of features can range is area from 1 cm² to 100 cm².

Generally, one or more array of features can be configured such that there can be different layers of arrays of features. Each layer comprising an array of features can be any suitable size. In some examples, a layer can be at least about 0.1 nm, 0.5 nm, 1.0 nm, 10 nm, 20 nm, 30 nm, 40 nm, 50 nm, 60 nm, 70 nm, 80 nm, 90 nm, 100 nm, 150 nm, 200 nm, 250 nm, 300 nm, 350 nm, 400 nm, 500 nm, 550 nm, 600 nm, 650 nm, 700 nm, 750 nm, 800 nm, 850 nm 900 nm, 950 nm, 1000 nm, 1250 nm, 1500 nm, 1750 nm, or 2000 nm. In some cases, features can be spaced at most about 0.1 nm, 0.5 nm, 1.0 nm, 10 nm, 20 nm, 30 nm, 40 nm, 50 nm, 60 nm, 70 nm, 80 nm, 90 nm, 100 nm, 150 nm, 200 nm, 250 nm, 300 nm, 350 nm, 400 nm, 500 nm, 550 nm, 600 nm, 650 nm, 700 nm, 750 nm, 800 nm, 850 nm 900 nm, 950 nm, 1000 nm, 1250 nm, 1500 nm, 1750 nm, or 2000 nm. In some examples, a layer thickness can range is area from 10 nm to 100 nm. In some examples, a layer thickness can range is area from 100 nm to 1000 nm. In some examples, a layer thickness can range is area from 50 nm to 1600 nm. In some examples, a layer thickness can range is area from 1000 nm to 2,000 nm. In some examples, a layer thickness can range is area from 100 nm to 200 nm.

### IV. Generation of Coherent Resonating Modes and Coupling to Propagating Wavelength

Generally, the array of features of the systems and methods of the present disclosure can include a surface state where waves of certain modes can propagate. In certain examples, coherent resonating modes can be generated. A surface state can exist at a boundary between two materials, material layers, or material and a medium with different dielectric constants. In certain examples, resonating modes generated by the interaction of incident wavelengths of low, partial, or non-coherent light can include the interaction of radiation with at least one medium with a negative dielectric constant and at least one medium with a positive dielectric constant. Such surface states are described in Robert D. Meade, Karl D. Bommer, Andrew M. Rappe, and J. D. Joannopolous, Electromagnetic Bloch Waces in the Surface of a Photonic Crystal, Physical Review B, Vol 44, 10961 (1991), which is incorporated herein by reference. Such an interface can be between an array of features and another material, such as another metal, another array of features a dielectric or a medium. In some examples, the array of features can include a coherent propagating mode interacting with a medium such as gas, air, or a vacuum.

Generally, the dielectric constant or permittivity of the material containing the array of features can interact with a medium with a different dielectric constant or permittivity. In some examples, generating two or more spatially coherent optical resonating modes through the interaction the one or more incident wavelengths of electromagnetic radiation and the array of features comprises interaction of electromagnetic radiation with at least one first medium having a negative dielectric constant and at least one second medium having a positive dielectric constant. In some examples, the array of features can include a metal, such as gold, silver or copper. At optical frequencies, such metals can have a negative dielectric constant. In some examples, such metals may have a dielectric constant of less than 1. The dielectric constant can be affected by the incident wavelength of light. In some examples, the array of features may interact with another medium with a dielectric constant different than that of the array of features. In some examples, an array of features generated from gold or silver can interact with a vacuum, wherein the vacuum has a dielectric constant of 1. In some examples, an array of features generated from gold or silver can interact with air, wherein the air has a dielectric constant of about 1. In some examples, an array of features generated from gold or silver can interact with another layer of material, wherein the material has a dielectric constant of greater than 1. By way of example, the array of features, made out of a metal such as gold, silver, or copper having a lower or negative dielectric constant can interact with a second medium with a positive or higher dielectric constant such as glass (dielectric constant ranging from 5-10), mica (dielectric constant ranging from 3-6), or mylar (dielectric constant about 3.6).

Generally, incident wavelengths of magnetic radiation are used to transfer energy from a low, partial or non-coherent light source into a structure containing an array of features, such as a patterned nanostructure surface, a photonic crystal or the like. Photons of the incident wavelengths excite the material of the feature of the arrays. In some examples, photons can be trapped in or between features of the array. Because a surface state is confined to within a limited range of the photonic crystal or nanostructured interface with its modal envelope decaying rapidly away from the interface, surface states have a similar confinement and surface propagation characteristics as plasmons. In some cases, interaction of incident wavelengths of electromagnetic radiation generates surface plasmonic resonance. Surface plasmonic resonance can be used to generate spatially coherent wave modes that can then be coupled to a propagating wave for transmission as coherent light, or light with higher coherence than the incident wavelengths of light.

Generally, the spacing and materials chosen and design of the array of features can impact the ability to couple coherent resonating modes with a propagating wave useful for transmission of coherent or more coherent light. In certain examples, coupling reflect the number of photons that be exchanged between areas in or around individual features of the array. In some instances, coupling can be at least 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, or 99%. In some examples, coupling can be at most 1%, 2%, 3%, 4%, 5%, 6%, 7%, 8%, 9%, 10%, 15%, 20%, 25%, 30%, 35%, 40%, 45%, 50%, 55%, 60%, 65%, 70%, 75%, 80%, 85%, 90%, 95%, or 99%. In some examples, coupling can range from 1%-30%. In some examples, coupling can range from 10%-50%. In some examples, coupling can range from 25%-75%. In some examples, coupling can range from 30%-99%. In some examples, coupling can range from 40%-90%. In some examples, coupling can range from 50%-90%.

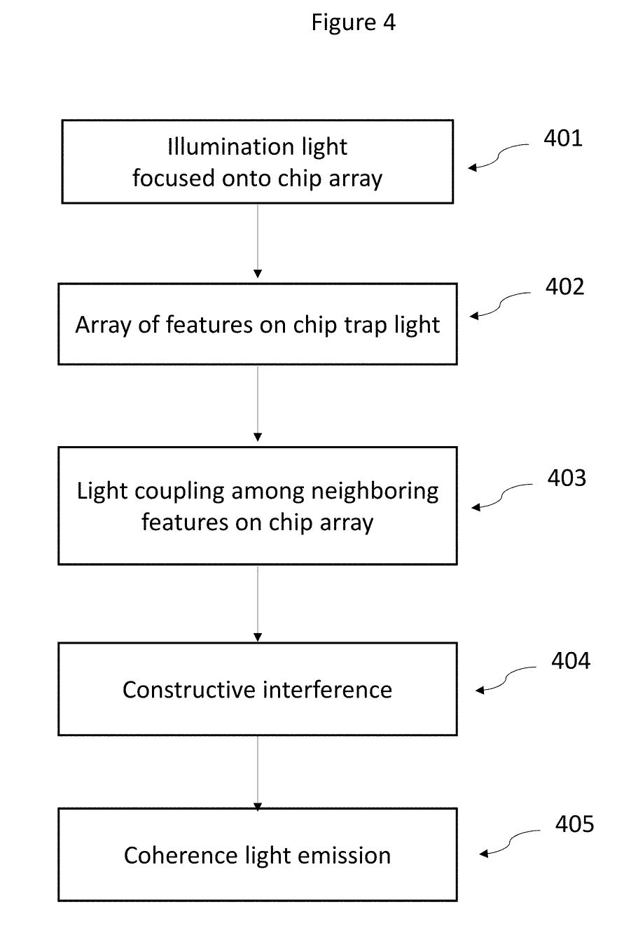

FIG. 4 provides an example of how light can interact with the array of features to generate coherent light. The flow chart of FIG. 4 is provided for an example method of light interaction with the array of features to generate coherent light; numerous aspects of light-array interactions mechanisms are possible, dependent on the design and selection of array features. As recited in FIG. 4, at block 401, illumination light is focused onto a chip array through the receiving of one or more low or partial wavelengths of incident light. In some examples, at block 402, this can include but is not limited to the array of features being designed such that photons of incident wavelengths of light can be trapped in the array. In a further non-limiting example, photons can become trapped in an array of nanoholes. At block 403, the array of features can be designed and configured to allow for coupling. In some examples, this can include but is not limited to the exchange or transfer of photons trapped in or around one or more features with photons of adjacent or neighboring features. In some examples, at block 404, coupling of photons in the array of features can lead to numerous properties, including but not limited to constructive interference. At block 405, constructive interference can be desirable to generate coherent light, which can then be emitted from the device, for example.

### V. Configurations and Applications

Generally, one or more arrays of features can be used to generate coherent light. In some examples, one or more arrays are can be arrayed to generate coherent light on a focal spot. In some cases, one or more arrays can be aligned in a parallel fashion in which propagating light is gradually focused from a large spot size to a smaller spot size. In some examples, two or more arrays can be configured as a cone, wherein arrays of features are configured as a series of circular parallel arrays, wherein the area of individual areas are progressively reduced in area. The progressive reduction in area allows for transmitted light, via the propagating light in each area to become condenses into smaller and smaller spot size.

In some examples, one or more arrays of features can be configured to condense the spot to at least about 1 micron, 5 microns, 10 microns, 25 microns, 50 microns, 75 microns, 100 microns, 125 microns, 150 microns, 175 microns, 200 microns, 225 microns, 250 microns, 275 microns, 300 microns, 500 microns, 750 microns, 1000 microns. In some examples, one or more arrays of features can be configured to condense the spot to at most about 1 micron, 5 microns, 10 microns, 25 microns, 50 microns, 75 microns, 100 microns, 125 microns, 150 microns, 175 microns, 200 microns, 225 microns, 250 microns, 275 microns, 300 microns, 500 microns, 750 microns, 1000 microns. In some examples, the spot size can range from 10 microns-150 microns. In some examples, the spot size can range from 25 microns-200 microns. In some examples, the spot size can range from 100 microns-1000 microns.

In some examples, the two or more wavelengths of coherent electromagnetic radiation generated by the methods and systems of the disclosure may be condensed to a spot suitable for coupling into a fiber optic cable. Generally, fiber optic cores can range from 1 to about 300 microns. In some cases, the diameter can depend on whether the fiber is single modal or multimodal. In some examples, the systems and methods of the present disclosure provide for a configuration of one or more array of features to condense the coherent wavelengths of electromagnetic radiation into a spot size desirable for efficient coupling into an optical fiber. For example, if a 3 μm diameter fiber is used, the emission spot size generated from the one or more array of features may be about 3 μm in diameter. In other examples, the emission spot size generated from the one or more array of features does not need to equal the diameter of the fiber. In some examples, the diameter of the of the emission spot size can be generated to allow enough light to be efficiently coupled into a fiber. In some examples, the emission spot size from the one or more array of features may be larger than the diameter of the fiber optic. For example, if a 3 μm diameter fiber is used, the emission spot size generated from the one or more array of features may be about 50 μm in diameter. In this example, the difference in sizes may still allow for efficient coupling of light into the fiber optic for a desired application or purpose. By way of another example, if a 3 μm diameter fiber is used, the emission spot size generated from the one or more array of features may be about 20 μm in diameter. By way of another example, if a 10 μm diameter fiber is used, the emission spot size generated from the one or more array of features may be about 50 μm in diameter.

In some examples, one more array of features can be configured to generate a spot size that can be efficiently coupled into optical fiber or wave guide. In some examples, a fiber taper can be used to reduce the spot size of light generated from one or more arrays of features. This can useful for any range of applications including but not limited to optical coherence tomography, optical microscopy, or endoscopy.

Generally, the device and systems of the disclosure are suitable for any applications wherein coherent light is useful. In some examples, applications can include those that include, optical coherence tomography (OCT), an imaging modality often used for medical imaging that uses light to capture micrometer-resolution, three-dimensional images from within optical scattering media (e.g., biological tissue). Optical coherence tomography is based on low-coherence interferometry, typically employing near-infrared light and more recently visible light. The use of relatively long wavelength light allows the light to penetrate into the scattering medium. In some examples, the systems and methods of the present disclosure can be used for spatially coherent sources, in the form of either highly collimated planewave or tightly confined focal spot. These can be suitable for any device requiring fiber optics, such as endoscope or embedded optical sensors; or integrated photonics that require mode coupling.

In other examples, other imaging modalities that utilize coherent light sources, such as confocal microscopy, another optical technique which typically penetrates less deeply into the sample but with higher resolution, can be used with the systems and methods of the disclosure.

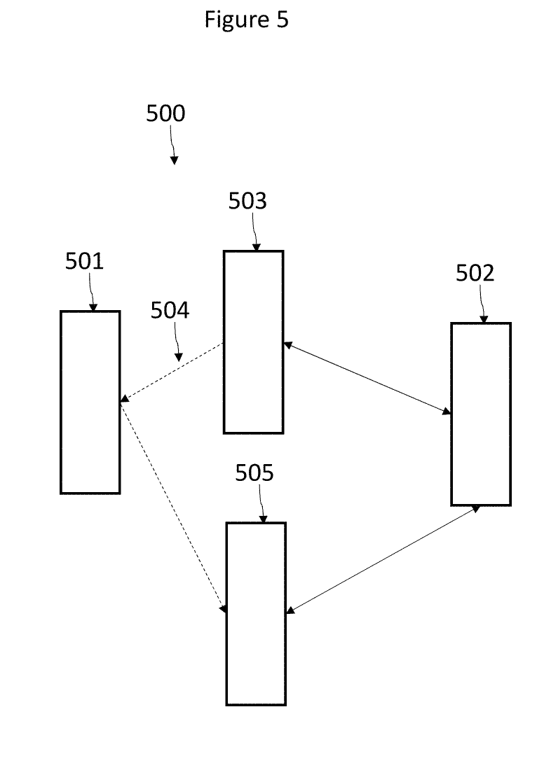

Referring to FIG. 5, a block diagram of a system 500 for generation of coherent light to a device 501 is shown as an example. The example system 500 includes a processing circuit 502 and a light source 503 for incident wavelengths of light 504. The processing circuit 502 includes components to control and monitor the incident light source 503 (e.g., processor(s), memory, buffer(s), input(s), output(s), peripherals, storage, circuit boards, etc.) and to monitor feedback provided by sensors configured to monitor the device 501. In one example, processing circuit 502 includes the processing components of a computing device (e.g., a computer, a laboratory device, etc.). The incident light source 503 includes components to generate and direct light at device 501. In one example, incident light source 503 includes a controllable diode (e.g., a LED, SLED, OLED, PLED, etc.). Incident light source 503 can be communicably connected to processing circuit 502. The device 501 can include one or more array of features or photonic crystal. The device 501 can also include sensors 505 configured to provide feedback related to an optical incident process. The sensors can be communicable connected to processing circuit 502 and the feedback can be utilized by processing circuit 502 in implemented the processes described herein.

In one example, processing circuit 502 includes a processor. The processor can be implemented as a general-purpose processor, an application specific integrated circuit (ASIC), one or more field programmable gate arrays (FPGAs), a group of processing components, or other suitable electronic processing components. Processing circuit 502 can also include a memory. The memory can include one or more devices (e.g., RAM, ROM, Flash Memory, hard disk storage, etc.) for storing data and/or computer code for facilitating the various processes described herein. The memory can be or include non-transient volatile memory or non-volatile memory. The memory can include database components, object code components, script components, or any other type of information structure for supporting the various activities and information structures described herein. The memory can be communicably connected to the processor and include computer code or instructions for executing the processes described herein (e.g., the processes shown in FIGS. 1, 4, etc.). In implementing the processes described herein, processing circuit 502 can make use of machine learning, artificial intelligence, interactions with databases and database table lookups, pattern recognition and logging, intelligent control, neural networks, fuzzy logic, etc.

The construction and arrangement of the systems and methods as shown in the various examples are illustrative only. Although only a few examples have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative examples. Other substitutions, modifications, changes, and omissions can be made in the design, operating conditions and arrangement of the examples without departing from the scope of the present disclosure.

The present disclosure contemplates methods, systems and program products on any machine-readable media for accomplishing various operations. The examples of the present disclosure can be implemented using existing computer processors, or by a special purpose computer processor for an appropriate system, incorporated for this or another purpose, or by a hardwired system. Examples within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can include RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, blocks, or elements, the order of the steps, blocks, and/or elements may differ from what is depicted. Also, two or more steps, blocks, and/or elements may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

While various aspects and examples have been disclosed herein, other aspects and examples will be apparent to those skilled in the art. The various aspects and examples disclosed herein are for purposes of illustration and are not intended to be limiting, with the true scope and spirit being indicated by the following claims.

### EXAMPLES

### Example 1

This example provides generation of plasmonic nanostructures. A nano-hole target pattern, suitable for the systems and methods of the present disclosure was fabricated using Focused-Ion-Beam (FIB) and Electro-beam-lithography (EBL) techniques on gold/silver thin films deposited on quartz substrates.

For the FIB process, the quartz substrates were sputtered with a 100-nm-thick silver/gold film by electro-beam evaporator. In the process of milling holes, the Ga+ ion beam was set to 30 keV with a beam current of 40 pA. For the EBL process, the quartz substrate was spin coated with PMMA as sacrificial stencil layer and then exposed the inverse pattern by using an EBL system. After the patterning with EBL, 100-nm-thick silver/gold film was deposited by electro-beam evaporator. After the deposition of targeting metal, the sacrificial layer together with the target material on its surface was washed. This allowed the target pattern to remain on the quartz substrate. Planar arrays of the nano-hole target pattern fabricated by this method and others were designed to have the same tunable aperture diameter and same lattice. The overall size of the arrays fabricated were 40 μm×40 μm.

### Example 2

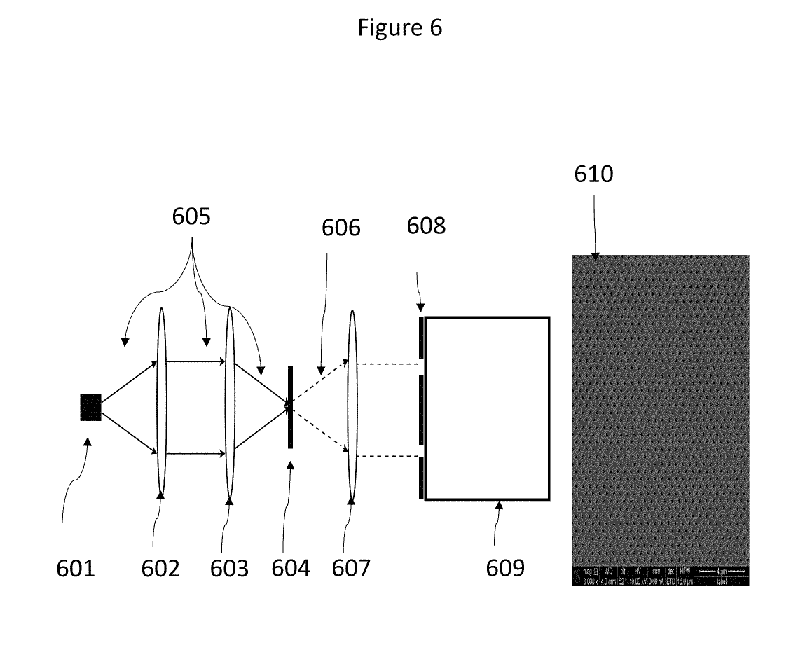

As shown in FIG. 6, a device of the present disclosure is constructed to generate coherent light. A wideband illumination source 601 (MWWHL4, Thorlabs, etc.) covering visible range (e.g., 400 nm to 700 nm, etc.) is first collimated by a collimating lens 602 (e.g., with diameter in 50 mm and focal length in 32 mm (e.g., SM2F32-A, Thorlabs, etc.), etc.). The collimated light is then focused by a lens 603 (e.g., with a focal length of 6 mm (e.g., Edmund), etc.) onto a chip array with features 604.

In the chip array, a hexagon lattice of holes is used (e.g., diameter is 150 nm, thickness of the thin film is 100 nm, etc.) as features, and the material is gold 610, for example. Due to the relatively high filling ratio than square lattice with similar periodicity, the hexagon lattice with gold material can be selected to get achieve higher transmission at visible wavelengths, thus achieving high conversion efficiency.

In order to achieve the plasmonic resonance in visible wavelength range, different periodicity of the hexagon lattice can be chosen to simulate the transmission spectra by a finite-difference time-domain (FDTD) method. In addition, the diameter of the holes and the thickness of the metal film are additional design parameters that can be optimized and/or otherwise improved. Third, the selection of the materials (such as aluminum, silver, or copper) to construct the hole array can be optimized or improved to maximize and/or otherwise improve the transmission of the subjecting operational wavelength range and extended the life time of the proposed hole array under a normal operational condition.

A focal length ratio between lens 602 and lens 603 can be selected to ascertain a tight focus on chip array 604 with resulting pattern 610. For example, if the LED size of element 601 is 5 mm in diameter, and the chip size features 604 is 1 mm in diameter, then the focal length ratio between 602 and 603 is selected to be 5 to image the 5 mm LED onto 1 mm chip. The LED power is selected high enough to ascertain high emission of 604. In this example, the focal length ratio is selected between 602 and 603 as 5, and the LED power is approximately 500 mW.

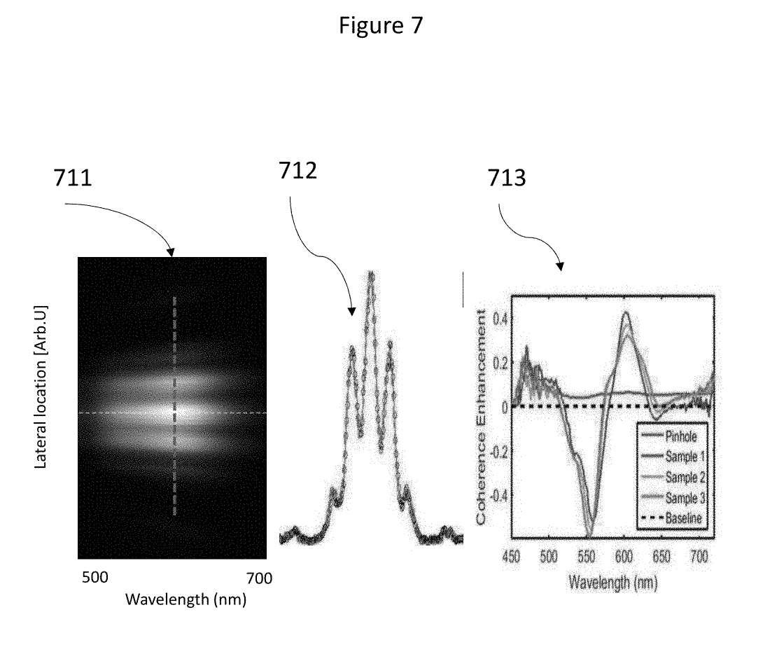

Before coupling the light emission from chip array, the spatial coherence of the light emerging from the chip array with features can be tested. Spatial coherence at each wavelength can be measured using Young's double slits setup 608 and spectrometer 609. FIG. 7 illustrates example data regarding the light generated from the example device of FIG. 6. FIG. 7 shows an interference pattern acquired by the spectrometer 609 is shown in 711, from which it can be seen that the spherical waves emerging from the double slits interfere creating intensity fringes that scale as a function of the wavelength. For clarity, 712 shows the interference profile of wavelength at 603 nm (e.g., extracted from the red dash line in 711). Using this results, coherence of emission light at each wavelength can be quantified by calculating the coherence degree as:

$$Coherence = \frac{Im ax - Im in}{Im ax + Im in}$$

where Iₘₐₓ is the brightest intensity in the interference fringe resulting from constructive interference, and Iₘᵢₙ is the neighboring dimmest intensity in the interference fringe resulting from destructive interference. Coherence from three sample array chips with features were calculated; one pinhole (e.g., diameter 100 μm, etc.), and the reference (e.g., pure illumination, no pinhole, no array chip). The results are shown in 713 indicating that the chip array with features can enhance or increase coherence to 40% (e.g., at wavelength 603 nm, etc.), for example.

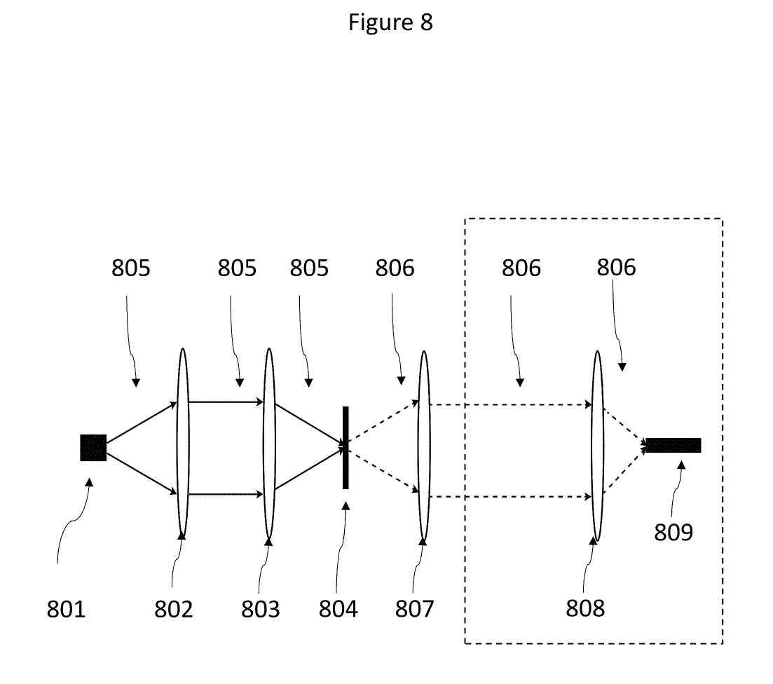

FIG. 8 shows a schematic diagram for coupling light generated by the systems, devices and methods of the disclosure into the fiber illustrated. An illumination source 801 (e.g., SLED, etc.) generates incident wavelengths of light through an illumination light path 805. Light from the SLED is first passed through a collimation lens 802 and then through a focal lens 803. The coherence emission is direct along an emission path 806, from the chip with an array of features 804 and is firstly collimated by a collimating lens 807 and focused by a focal lens 808, onto a fiber tip 809. In an example, since the fiber core in visible range is 3 μm, and the numerical aperture is 0.13. To enhance coupling efficiency, the emission can be focused tightly onto the fiber tip 809, while also helping to ensure that a numerical aperture of the focal lens 808, matches the numerical aperture of the fiber 809.

### Example 3

To test the usefulness of the plasmonic nanostructure based broadband coherent light source, the device can be used as source of coherent light for a visible light optical coherence tomography device visible-OCT (also referred to as vis-OCT, functional OCT, or fOCT), as described, for example, in U.S. patent application Ser. No. 14/698,641, incorporated by reference herein. Systems, devices and methods of vis-OCT requires a broadband coherent light source. In some examples, Vis-OCT can be used with a broadband visible light laser as a source for coherent light. The plasmonic nanostructure based broadband coherent light can be adapted to replace a laser based source to perform vis-OCT, where the light source to produce the two or more incident wavelengths of light can be white light SLED capable of generating multiple wavelengths in the visible light spectrum. Methods of vis-OCT can be optimized and/or otherwise improved by minimizing and/or reducing influence from polarization and dispersion, where polarization effects can be adjusted with a polarization controller in the imaging system, and dispersion can be corrected digitally in data processing or with a glass plate compensation in the reference arm in a vis-OCT setup, for example. Experimental results can also be used to guide the further optimization/improvement of the theoretical design of the plasmonic nanostructure based broadband light source. The high axial resolution of vis-OCT can be first examined in phantom experiments; for example, the axial point spread function can be acquired by directly imaging a silver mirror as the sample. The roll-off sensitivity can also be quantified by imaging a silver mirror as the sample, while moving reference arm within the range of coherence length. After calibration, blood oxygen saturation (sO2) values can be quantified in phantom blood with vis-OCT. A series of blood phantoms with different sO2 readings can be prepared and imaged by vis-OCT. Corresponding blood sO2 can then be calculated from vis-OCT fundus images with our established spectrum analysis algorithms. The measured sO2 can be compared to preset sO2 readings in blood phantoms to evaluate the accuracy of vis-OCT performance using the plasmonic nanostructure based broadband light source. Additional tests can be conducted to compare and contrast the performance of this Vis-OCT with a Vis-OCT system that relies on a laser based light source, for example.

### Example 4

In certain configurations, multiple devices can be coordinated or arrayed. One embodiment of the device can include a plurality of individual arrays, arranged such that coherent light generated as the output of individual arrays are combined and focused into a desired spot size.

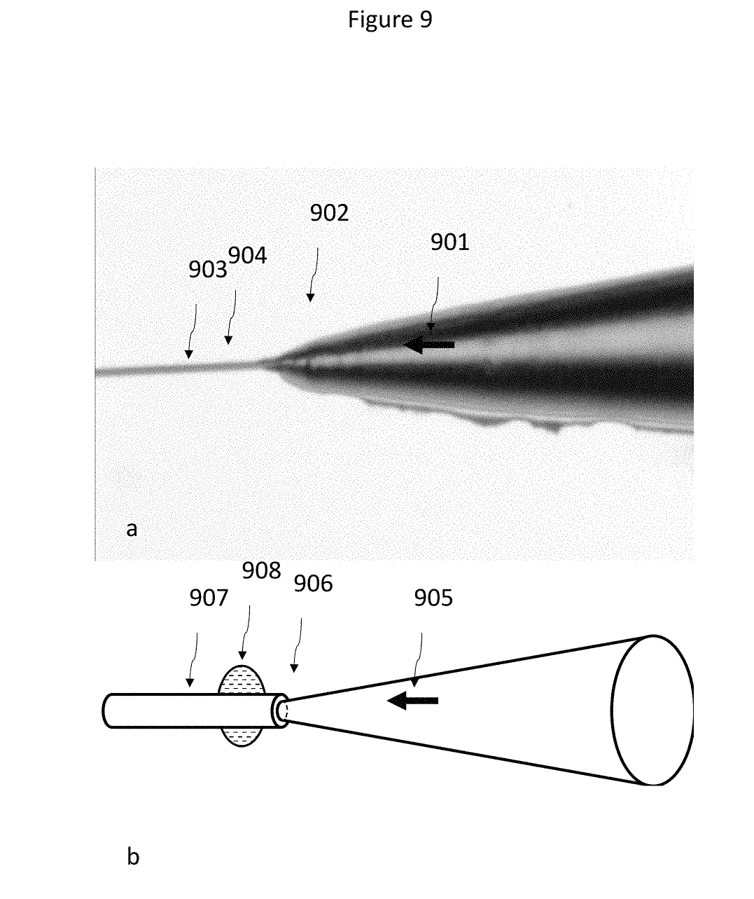

As shown in FIG. 9, this example provides an example coupling of the non-coherent emission from LED (901, 905) into a spatially confined focal spot using a photonic mode coupler in the shape of a taper with circular cross-section (902, 906). Upon coupling into the photonic mode coupler (902, 906), coherent light is subsequently launched into the entrance pupil of the single mode fiber (903, 907). The taper angle can be optimized or otherwise improved by the overall transmission of the device by 1) providing adiabatic coupling of the incident light to reduce or minimize the energy loss due to the reflection and 2) shortening the device length to reduce or minimize the propagation loss of the light confine within. UV-curable resin (904, 908) with high viscosity and low refractive index (e.g., ˜1.33, etc.) can be used for dual purposes here: 1) as the glue to attach the photonic mode coupler (902, 906) to the single mode fiber while maintaining the optimal alignment and 2) as the low index cladding layer to preserve the confinement of the light within the photonic mode coupler (902, 905).

### Example 5

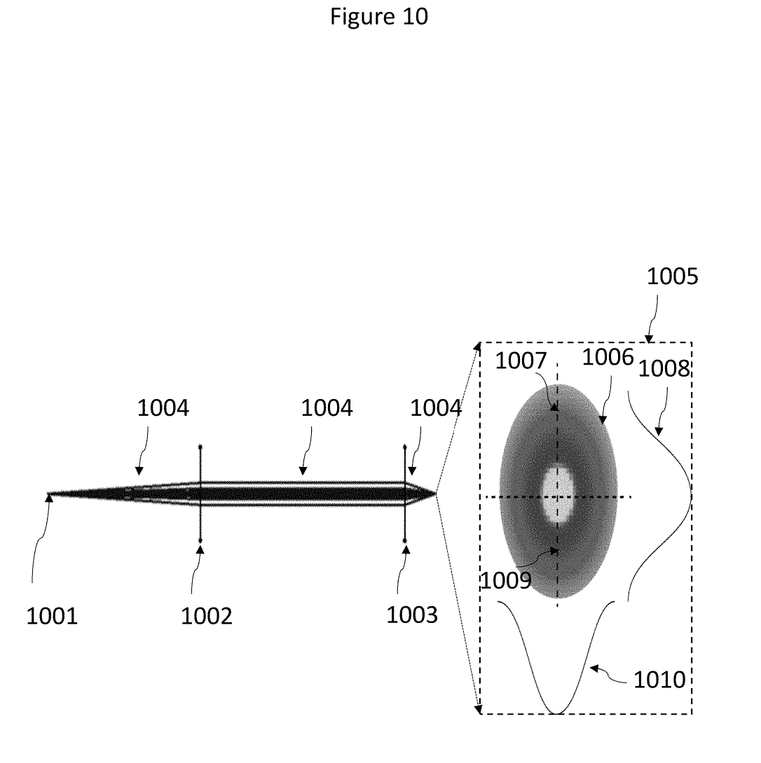

This example provides for a simulated optical setup (e.g., Zemax, etc.) for fiber coupling using the systems, methods and devices of the present disclosure as shown in FIG. 10. A focused emission beam (e.g., 50 μm in diameter, etc.) can be simulated generated from array of features, or chip array 1001. In this example, the emission beam is first passed through a collimation lens 1002 for coherent emission. Coherent light is further passed through a focal lens 1003. In this simulation, the ratio of the focal length between lenses 1002 and 1003 is set to 5. The coherent light is guided through an emission beam path 1004 to a focal spot 1005. A two-dimensional cross sectional profile of focal spot 1005 after lens 1003 indicates that the beam diameter is 10μ micrometer with a coupling efficiency to a fiber with 3 μm diameter is up to 40% coherent 1006. The simulation shows the selected vertical position to extract a one-dimensional (1D) cross sectional profile of focal light distribution 1007 and the 1D cross section light distribution extracted for the simulation 1008. The Gaussian distribution is reflected in 1007. The simulation also reflects the selected horizontal position to extract 1D cross sectional profile of focal light distribution 1009 and 1D cross section light distribution extracted from Gaussian distribution 1010.

### Example 6

This example provides the application of the device of the present disclosure for one or more devices that require a form of coherent light. This example provides for the use of this device for medical imaging, as used in a visible light OCT ophthalmic device. A device can be deployed as a source of coherent Visible Light, to replace current sources such as supercontinuum visible light laser. The device of the present disclosure can provide a low cost and portable device that can be easily integrated into visible light OCT devices via fiber coupling. The device that will be used for visible light OCT can employ a fiber taper or a cone based configuration to achieve a spot size and power for medical imaging. The spot size generated by the device can be 1 mm and have a power of 0.8 mW or higher, for example.

As mentioned above, the example process(es) of FIGS. 1 and 4 may be implemented using coded instructions (e.g., computer and/or machine readable instructions) stored on a tangible computer readable storage medium such as a hard disk drive, a flash memory, a ROM, a CD, a DVD, a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example process(es) of FIGS. 1 and 4 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

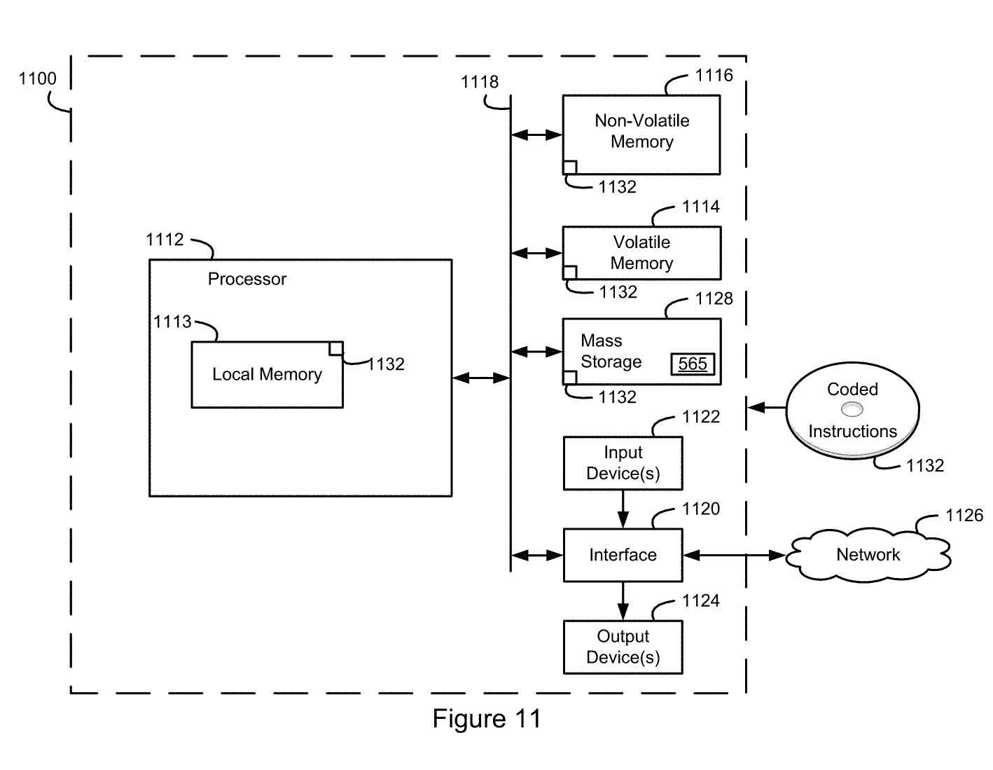

FIG. 11 is a block diagram of an example processor platform 1100 capable of executing the instructions of FIGS. 1 and 4 to implement the example systems and components disclosed and described herein with respect to FIGS. 2-3 and 5-10. The processor platform 1100 can be, for example, a server, a personal computer, or any other type of computing device.

The processor platform 1100 of the illustrated example includes a processor 1112. The processor 1112 of the illustrated example is hardware. For example, the processor 1112 can be implemented by one or more integrated circuits, logic circuits, microprocessors or controllers from any desired family or manufacturer.

The processor 1112 of the illustrated example includes a local memory 1113 (e.g., a cache). The processor 1112 of the illustrated example executes the instructions to implement, control, and/or drive one or more of the example light source 202, example array of features 203, example coupler 204, example generator 205, example collimator 206, example device 501, example processing circuit 502, example light source 503, example sensor 505, and/or, more generally, the example systems of FIGS. 2 and/or 5. The processor 1112 of the illustrated example is in communication with a main memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1116 may be implemented by flash memory and/or any other desired type of memory device. Access to the main memory 1114, 1116 is controlled by a memory controller.

The processor platform 1100 of the illustrated example also includes an interface circuit 1120. The interface circuit 1120 may be implemented by any type of interface standard, such as an Ethernet interface, a universal serial bus (USB), and/or a PCI express interface.

In the illustrated example, one or more input devices 1122 are connected to the interface circuit 1120. The input device(s) 1122 permit(s) a user to enter data and commands into the processor 1112. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1124 are also connected to the interface circuit 1120 of the illustrated example. The output devices 1124 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 1120 of the illustrated example, thus, typically includes a graphics driver card, a graphics driver chip or a graphics driver processor.

The interface circuit 1120 of the illustrated example also includes a communication device such as a transmitter, a receiver, a transceiver, a modem and/or network interface card to facilitate exchange of data with external machines (e.g., computing devices of any kind) via a network 1126 (e.g., an Ethernet connection, a digital subscriber line (DSL), a telephone line, coaxial cable, a cellular telephone system, etc.).

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, RAID systems, and digital versatile disk (DVD) drives.

The coded instructions 1132 of FIGS. 1 and/or 4 may be stored in the mass storage device 1128, in the volatile memory 1114, in the non-volatile memory 1116, and/or on a removable tangible computer readable storage medium such as a CD or DVD.

From the foregoing, it will appreciate that the above disclosed methods, apparatus and articles of manufacture facilitate improved generation of coherent light. In certain examples, a method includes: receiving two or more incident wavelengths of electromagnetic radiation; applying the two or more incident wavelengths of electromagnetic radiation to an array of features; generating two or more spatially coherent optical resonating modes through the interaction of the one or more incident wavelengths of electromagnetic radiation and the array of features; and coupling the two or more spatially coherent optical resonating modes to two or more spatially coherent propagating wavelengths of electromagnetic radiation, wherein the spatially coherent propagating wavelengths of electromagnetic radiation are identical to the two or more incident wavelengths of electromagnetic radiation.

In certain examples, a system is configured to generate spatially coherent electromagnetic radiation, the system including one or more mediums including an array of features configured to receive two or more wavelengths of electromagnetic radiation; one or more mediums configured to generate one or more spatially coherent optical resonating modes; and one or more mediums configured to generate one or more spatially coherent propagating wavelengths of electromagnetic radiation.

In certain examples, a computer readable storage medium includes instructions which, when executed by a processor, implement the example method(s) and/or system(s) described above.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A method comprising:
a. receiving two or more incident wavelengths of electromagnetic radiation;
b. applying the two or more incident wavelengths of electromagnetic radiation to an array of features;
c. generating two or more spatially coherent optical resonating modes through the interaction of the one or more incident wavelengths of electromagnetic radiation and the array of features; and
d. coupling the two or more spatially coherent optical resonating modes to two or more spatially coherent propagating wavelengths of electromagnetic radiation, wherein the spatially coherent propagating wavelengths of electromagnetic radiation are identical to the two or more incident wavelengths of electromagnetic radiation.

2. The method of claim 1, wherein the two or more spatially coherent propagating wavelengths of electromagnetic radiation comprise wavelengths of higher coherence than the coherence of the incident wavelengths.

3. The method of claim 1, wherein the array of features further comprises at least one of a periodic, quasi-random, quasi-order or random arrangement of features.

4. The method of claim 1, wherein the features comprise one or more structures with a dimension size less than a first wavelength of at least one of the incident wavelengths of electromagnetic radiation.

5. The method of claim 1, wherein the features in the array of features comprise at least one of nanostructures, plasmonic structures, photonic optical resonators, photonic cavities, holes, nano-holes, nano-pores, or textured surfaces.

6. The method of claim 1, wherein the array of features is configured to produce the one or more spatially coherent optical resonating modes from the one or more incident wavelengths of electromagnetic radiation.

7. The method of claim 1, wherein the generating two or more spatially coherent optical resonating modes through the interaction the one or more incident wavelengths of electromagnetic radiation and the array of features comprises interaction of electromagnetic radiation with at least one first medium having a negative dielectric constant and at least one second medium having a positive dielectric constant.

8. The method of claim 7, wherein the array of features comprise at least one of glass spheres or nanospheres.

9. The method of claim 8, wherein the generating one or more spatially coherent optical resonating modes through the interaction the one or more incident wavelengths of electromagnetic radiation and the array of features further comprises surface plasmonic resonance.

10. The method of claim 1, wherein the generating one or more spatially coherent optical resonating modes through the interaction the one or more incident wavelengths of electromagnetic radiation and the array of features comprises interaction of electromagnetic radiation with one or more layers of mediums with different dielectric constants.

11. The method of claim 1, wherein the one or more spatially coherent propagating wavelengths of electromagnetic radiation further comprises focusing the propagating wavelength into one or more spots, wherein each spot is at most 1 millimeter (mm).

12. The method of claim 11, wherein the spots comprise a diameter that facilitates coupling of the propagating wavelengths into at least one of an optical fiber or wave guide.

13. The method of claim 17, wherein the two or more spatially coherent optical resonating modes coupled to the two or more spatially coherent propagating wavelengths of electromagnetic radiation are provided to an imaging device configured for at least one of optical coherence tomography, optical microscopy, or endoscopy.

14. The method of claim 1, wherein the receiving one or more incident wavelengths of electromagnetic radiation comprises receiving electromagnetic radiation from at least one of a lamp, light emitting diode, laser, super luminescent diode, or electromagnetic radiation emitting device.

15. A system configured to generate spatially coherent electromagnetic radiation, the system comprising one or more mediums including an array of features configured to receive two or more wavelengths of electromagnetic radiation; one or more mediums configured to generate one or more spatially coherent optical resonating modes; and one or more mediums configured to generate one or more spatially coherent propagating wavelengths of electromagnetic radiation.

16. The system of claim 15, wherein the two or more spatially coherent propagating wavelengths of electromagnetic radiation comprise wavelengths of higher coherence than the coherence of the incident wavelengths.

17. The system of claim 15, wherein the array of features further comprises at least one of a periodic, quasi-random, quasi-order or random arrangement of features.

18. The system of claim 15, wherein the features comprise one or more structures with a dimension size less than a first wavelength of at least one of the incident wavelengths of electromagnetic radiation.

19. The system of claim 15, wherein the features in the array of features comprise at least one of nanostructures, plasmonic structures, photonic optical resonators, photonic cavities, holes, nano-holes, nano-pores, or textured surfaces.

20. The system of claim 15, wherein the array of features is configured to produce the one or more spatially coherent optical resonating modes from the one or more incident wavelengths of electromagnetic radiation.

21. The system of claim 15, wherein the two or more spatially coherent optical resonating modes are to be generated through the interaction the one or more incident wavelengths of electromagnetic radiation and the array of features comprises interaction of electromagnetic radiation with at least one first medium having a negative dielectric constant and at least one second medium having a positive dielectric constant.

22. The system of claim 21, wherein the array of features comprise at least one of glass spheres or nanospheres.

23. The system of claim 22, wherein the one or more spatially coherent optical resonating modes are to be generated through the interaction the one or more incident wavelengths of electromagnetic radiation and the array of features further comprises surface plasmonic resonance.

24. The system of claim 15, wherein the one or more spatially coherent optical resonating modes are to be generated through the interaction the one or more incident wavelengths of electromagnetic radiation and the array of features comprises interaction of electromagnetic radiation with one or more layers of mediums with different dielectric constants.

25. The system of claim 15, wherein the one or more spatially coherent propagating wavelengths of electromagnetic radiation further comprises focusing the propagating wavelength into one or more spots, wherein each spot is at most 1 millimeter (mm).

26. The system of claim 25, wherein the spots comprise a diameter that facilitates coupling of the propagating wavelengths into at least one of an optical fiber or wave guide.

27. The system of claim 15, wherein the two or more spatially coherent optical resonating modes coupled to the two or more spatially coherent propagating wavelengths of electromagnetic radiation are provided to an imaging device configured for at least one of optical coherence tomography, optical microscopy, or endoscopy.

28. The system of claim 15, wherein the one or more incident wavelengths of electromagnetic radiation are to be received from at least one of a lamp, light emitting diode, laser, super luminescent diode, or electromagnetic radiation emitting device.

29. A computer readable storage medium including instructions which, when executed by a processor, implement the method of any of claims 1-14.
